(19) United States
(12) Patent Application Publication
(10) Pub. No.: US 2012/0090954 A1
(43) Pub. Date: Apr. 19, 2012

(54) DEVICE FOR HANDLING OBJECTS

(75) Inventors: Ulrich Krauss, Ilshofen (DE); Steffen Humpfer, Satteldorf (DE)

(73) Assignee: ROBERT BOSCH GMBH, Stuttgart (DE)

(21) Appl. No.: 13/378,086

(22) PCT Filed: May 3, 2010
(86) PCT No.: PCT/EP10/55946

§ 371 Date: Dec. 14, 2011

(30) Foreign Application Priority Data
Jul. 3, 2009 (DE) 102009027462.6

(51) Int. Cl. B65G 29/00

(52) U.S. Cl. 198/339.1

(57) ABSTRACT

The invention relates to a device (10) for handling objects (1), comprising a handling device (11) which picks up objects (1) from a supply chamber and transfers the objects (1) to at least one processing station (22, 23) by means of a transfer device (15). According to the invention, the handling device (11) can pick up a specific number of objects at a time simultaneously by means of an object carrier (12). The transfer device (15) has multiple carrier elements (17) for the multiple objects (1) being carried at each time by the handling device (11). The sequence of motions of each carrier element (17) on the transfer device (15) can be controlled individually. Each time, the handling device (11) takes out the multiple objects (1) from the respective carrier element (17) again, once said objects pass through the at least one processing station (22, 23), and transfers the objects onto the object carrier (12).

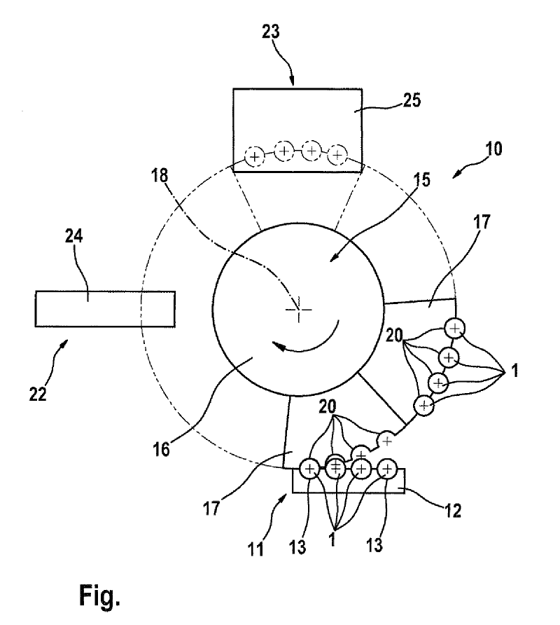

### BACKGROUND OF THE INVENTION

The invention relates to a device for handling objects.

A device of this type is already commonly known and is used in the packaging industry, in particular to feed pharmaceutical containers, such as vials, ampoules or the like, to a sealing station. Devices are known which have a feed star, which is loaded with the vials or containers by means of a screw conveyor. Solutions in which containers configured as ampoules are transferred via a separating device to a conveyor belt, which feeds the containers to the individual working stations, are also known.

### SUMMARY OF THE INVENTION

Starting from the represented prior art, the object of the invention is to refine a device for handling objects such that this can be flexibly adapted to different requirements and also has a relatively small installation space. It is further desirable that only a relatively small number of objects are respectively located in the region of the respective working station. This object is achieved in a device for handling objects.

A particularly compact construction of the device, combined with high flexibility with respect to the operating method or working method of the respective working stations, is enabled if the transfer device is configured as a conveyor wheel, having a plurality of circular-segment-like carrier elements which are movable about a longitudinal axis of the conveyor wheel, and if the totality of the carrier elements covers only a partial area on the periphery of the conveyor wheel, so that interspaces are at least periodically formed between the individual carrier elements.

Particularly good adaptation to the various working stations, so that these can operate as effectively as possible, is enabled if the carrier elements are continuously and cyclically movable.

In an advantageous refinement, it is provided that the handling device is configured as a handling robot, to which the object carrier is exchangeably fastened, and that the mutual spacing between the objects in the object carrier corresponds to the mutual spacing of the objects in the carrier element. Hence, when the objects are delivered to the transfer device or taken up from this, a simple motional sequence of the handling device is obtained, the handling device, as a result of the configuration as a handling robot, being able to be very flexibly adapted to different spatial relationships between the device for handling the objects and a supply area in which the objects are taken up by the handling robot.

In this context, it is particularly advantageous for the frictionless take-up or delivery of the objects if the objects in the object carrier are arranged in a straight row, and if the object carrier and the carrier element, during the delivery of the objects to the carrier element or the take-up from the carrier element, are moved tangentially past one another at the same speed.

In an alternative embodiment, it is provided that the handling device is configured as a handling robot, to which the object carrier is exchangeably fastened, and that the mutual spacing between the objects in the object carrier and the mutual spacing of the objects in the carrier element is different. It is hence also possible to take up the objects by means of the handling device at a supply area, at which the objects in their carrier plate are arranged at a different distance apart than in the carrier element.

In order to enable a frictionless delivery of the objects to the transfer device, it is here provided, in particular, that the objects in the object carrier are arranged in a straight row, and that the object carrier and the carrier element, during the delivery of the objects to the carrier element or the take-up from the carrier element, are moved tangentially past one another, the speed of the object carrier being periodically different than the speed of the carrier element during delivery and take-up.

A particularly compact construction of the device according to the invention is additionally enabled if the delivery of the objects into the carrier element and the take-up of the objects from the carrier element takes place at the same site on the device.

A particularly secure handling without additional delivery devices is enabled if the objects, between the take-up from the handling device and the delivery from the transfer device, are always disposed in the carrier elements.

Preferably, the device is used for objects which are configured as vials or cartridges which are fillable with a pharmaceutical product, at least one working station comprising at least one sealing station for sealing the objects with a sealing element, in particular a crimp cap.

### BRIEF DESCRIPTION OF THE DRAWING

In the single FIGURE, an inventive device for handling pharmaceutical objects is shown in a simplified top view.

### DETAILED DESCRIPTION

A device 10 for handling objects 1 is represented in the FIGURE. The objects 1 are constituted, in particular, by pharmaceutical containers, such as vials, cartridges or the like, which have previously been filled with a pharmaceutical product and must then be sealed with a sealing element (not represented), in particular in the form of a crimp cap. The device 10 here serves to feed the objects 1 to the various working stations.

The device 10 comprises a handling robot 11 having an object carrier 12 configured as a format part. The object carrier 12 is of rectilinear configuration and in the illustrative embodiment has four receiving fixtures 13 for the objects 1, which are arranged at respectively an equal distance apart in a straight line. By means of an arm (not represented) of the handling robot 11, to which the object carrier 12 is exchangeably fastened, the object carrier 12 is movable between a supply area, at which it removes the objects 1 from a carrier plate, and the delivery position represented in the FIGURE, at which the objects 1 are delivered to a transfer device 15 by means of the handling robot 11.

The transfer device 15 has a circular conveyor wheel 16. On the outer periphery of the conveyor wheel 16 there are arranged a plurality of, for example two, carrier plates 17, which are mounted in the conveyor wheel 16 and which are movable for example clockwise, about a longitudinal axis 18 of the conveyor wheel 16. To this end, on the conveyor wheel 16, for example, there is configured a circumferential external tooth system (not represented), which meshes with a gearwheel (likewise not represented) disposed on the carrier plate 17. The gearwheel is coupled to a drive mechanism, so that all carrier plates 17 are individually movable on the conveyor wheel 16.

On the outer periphery of the circular-segment-like carrier plate 17 there are likewise arranged, in the illustrative embodiment, four receiving fixtures 20 for the objects 1, the mutual spacing of which corresponds to the mutual spacing of the objects 1 in the object carrier 12. In that position of the object carrier 12 which is represented in the FIGURE, the objects 1 are delivered from the object carrier 12 into the receiving fixtures 20 of the carrier plate 17. The carrier plate 17 here performs a linear, i.e. rectilinear movement tangentially along the motional path of the object carrier 12, the individual objects 1 being gradually delivered into the carrier plate 17. Along the further motional path of the carrier plate 17 in the clockwise direction, two further working stations 22 and 23, for example, are arranged. The first working station 22 is configured as a cap delivery device 24. In the cap delivery device 24, a crimp cap consisting of aluminum, for example, or a sealing element consisting of aluminum, is respectively placed onto the previously filled object 1. This can be realized by means of chutes or ramps, beneath which the objects 1 are fed past, whereupon the head region of the objects 1 respectively extracts a crimp cap or a sealing element. The cap delivery device 24 is adjoined by a crimping device 25. In the crimping device 25, the crimp caps or sealing elements are sealingly connected to the objects 1 or beaded over, so that the objects 1, after having left the crimping device 25, are airtightly sealed.

The working method of the device 10 is as follows: Following the delivery of the objects 1 from the object carrier 12 to a carrier plate 17, the latter is first moved into the region of the cap delivery device 24. A continuous movement, for example, takes place along the cap delivery device 24, in which movement the objects 1 respectively extract a crimp cap or a sealing element from a chute and take it along. The carrier plate 17 is then moved onward into the region of the crimping device 25, depending on the configuration of the crimping device 25 either a continuous movement of the carrier plate 17, and thus of the objects 1, along crimping rollers, or else a cyclical movement being realized, in which the carrier plate 17 stands still within the crimping device 25 to allow the crimping rollers to seal the crimp caps or the sealing elements on the individual objects 1. Next, following sealing of the objects 1 in the crimping device 25, the carrier plate 17 moves back in the direction of the original position in which the objects 1 were delivered from the object carrier 12 into the transfer device 15. At this original site, the delivery of the sealed objects 1, in turn, from the transfer device 15 into the object carrier 12 of the handling robot 11 is now realized.

The device 10 which has so far been described can be altered or modified in a variety of ways, without deviating from the inventive concept. It can be provided, for instance, that the crimping device 25 has only a single crimping station, which results in the individual objects 1 being fed cyclically to this individual crimping station. It is also conceivable to provide further or other working stations along the motional path of the objects 1 in the device 10. For instance, a pre-crimping device is conceivable, in which the sealing caps are pressed against the object 1 on two opposite sides. In place of sealing elements which are to be crimped, sealing plugs, for example, can also be provided, which sealing plugs, by being pressed into the head region of the objects 1, seal these. In addition, it can also be provided to dispense with a cap delivery device 24. In this case, it can be provided that the handling robot 11 takes up at another station a number of crimp caps corresponding to the number in the object carrier 12 and, prior to the removal of the objects 1 from their carrier plate, places these crimp caps onto the head regions of the objects 1 and, if need be, pre-crimps them.

1. A device (10) for handling objects (1), the device (10) comprising a handling device (11) which receives objects (1) from a supply area and which delivers the objects (1) by means of a transfer device (15) to at least one working station (22, 23), characterized in that the handling device (11) respectively simultaneously receives a specific number of objects by means of an object carrier (12), in that the transfer device (15) has a plurality of carrier elements (17) for the multiple objects (1) respectively taken up by the handling device (11), in that a motional sequence of each carrier element (17) on the transfer device (15) is individually controllable, and in that the handling device (11) removes the respectively multiple objects (1) from the respective carrier element (17) following their passage through the at least one working station (22, 23), and delivers them to the object carrier (12).

2. The device as claimed in claim 1, characterized in that the transfer device (15) is configured as a conveyor wheel (16), in that the conveyor wheel (16) has a plurality of circular-segment-like carrier elements (17) which are movable about a longitudinal axis (18) of the conveyor wheel (16), and in that a totality of the carrier elements (17) covers only a partial area on the periphery of the conveyor wheel (16), so that interspaces are at least periodically formed between individual carrier elements (17).

3. The device as claimed in claim 2, characterized in that the carrier elements (17) are continuously and cyclically movable.

4. The device as claimed in claim 3, characterized in that along a path of transport of the objects (1) a plurality of working stations (22, 23) are arranged, and in that the objects (1) at the working stations (22, 23) are moved one of continuously and cyclically while they are worked, depending on the type of working station (22, 23).

5. The device as claimed in claim 1, characterized in that the handling device is configured as a handling robot (11), to which the object carrier (12) is exchangeably fastened, and in that a mutual spacing between the objects (1) in the object carrier (12) corresponds to a mutual spacing of the objects (1) in the carrier element (17).

6. The device as claimed in claim 5, characterized in that the objects (1) in the object carrier (12) are arranged in a straight row, and in that the object carrier (12) and the carrier element (17), during the delivery of the objects (1) to the carrier element (17) or the take-up from the carrier element (17), are moved tangentially past one another at the same speed.

7. The device as claimed in claim 1, characterized in that the handling device is configured as a handling robot (11), to which the object carrier (12) is exchangeably fastened, and in that a mutual spacing between the objects (1) in the object carrier (12) and a mutual spacing of the objects (1) in the carrier element (17) is different.

8. The device as claimed in claim 7, characterized in that the objects (1) in the object carrier (17) are arranged in a straight row, and in that the object carrier (1) and the carrier element, during the delivery of the objects (1) to the carrier element (17) or the take-up from the carrier element (17), are moved tangentially past one another, the speed of the object carrier (12) being periodically different than the speed of the carrier element (17) during delivery and take-up.

9. The device as claimed in claim 1, characterized in that the delivery of the objects (1) into the carrier element (17) and the take-up of the objects (1) from the carrier element (17) is realized at a same site on the device (10).

10. The device as claimed in claim 1, characterized in that the objects (1), between the take-up from the handling device (11) and the delivery from the transfer device (15), are always disposed in the carrier elements (17).

11. The device as claimed in claim 1, characterized in that the objects (1) are one of vials and cartridges fillable with a pharmaceutical product, and in that the at least one working station (22, 23) comprises at least one sealing device (25) for sealing the objects (1) with a sealing element.

12. The device as claimed in claim 11, characterized in that the sealing element is a crimp cap.
